(19) United States
(12) Patent Application Publication
(10) Pub. No.: US 2015/0062171 A1
(43) Pub. Date: Mar. 5, 2015

(54) METHOD AND DEVICE FOR PROVIDING A COMPOSITION OF MULTI IMAGE LAYERS

(71) Applicant: SAMSUNG ELECTRONICS CO., LTD., Suwon-si (KR)

(72) Inventors: Yong-Kwon Cho, Yongin-si (KR); Kil-Whan Lee, Seoul (KR)

(21) Appl. No.: 14/449,552

(22) Filed: Aug. 1, 2014

(30) Foreign Application Priority Data
Aug. 29, 2013 (KR) 10-2013-0103325

(51) Int. Cl. G09G 5/397; G09G 5/14

(52) U.S. Cl. CPC G09G 5/397; G09G 5/14; G09G 2340/12
USPC 345/634

(57) ABSTRACT

A method for multi image layer composition includes dividing a frame buffer into tile areas, for each the area, determining image layers to be composited, for each tile area, generating a composite image layer by compositing its determined image layers, and merging the composite image layers into an overall composite image layer, wherein generating the composite image layers for at least one of the tiles comprises reading image layer information of the image layers from a top image layer to a bottom image layer, determining whether to read a lower image layer using the information of the image layers thereabove, if the lower image layer is determined not to be read, defining the image layer above the lower image layer as an effective bottom image layer, and compositing the effective bottom image layer with upper image layers, and not compositing the effective bottom image layer with an image layer thereunder.

### CROSS-REFERENCE TO RELATED APPLICATION

This application claims priority under 35 U.S.C, §119 to Korean Patent Application No. 10-2013-0103325 filed on Aug. 29, 2013 in the Korean Intellectual Property Office, the disclosure of which is incorporated by reference herein in its entirety.

### TECHNICAL FIELD

The present inventive concept relates to a method for providing a composition of multi image layers.

### DISCUSSION OF RELATED ART

In general, in a method for providing a composition of multi image layers, a plurality of source image layers are composited to generate a composite image layer. The method may be performed based on the transparency and area of each of the plurality of source image layers. The method may be performed by reading each of the plurality of source image layers from a bottom image layer to a top image layer, in other words, in a bottom-up manner, However, since each of the source image layers is read, a large number of memory accesses occur.

### SUMMARY

The present inventive concept provides a method for providing a composition of multi image layers, which can reduce accesses to a memory.

According to an exemplary embodiment of the present inventive concept, there is provided a method for providing a composition of multi image layers, the method including dividing a storage area of a frame buffer into tile areas, for each the area, determining image layers to be composited, for each tile area, generating a composite image layer by compositing its determined image layers, and merging the composite image layers of the respective tile areas into an overall composite image layer, wherein generating the composite image layer for at least one of the tile areas comprises reading image layer information of the image layers in an order from a top image layer to a bottom image layer, determining whether to read a lower image layer using the information of the image layers above the lower image layer, if the lower image layer is determined not to be read, defining the image layer above the lower image layer as an effective bottom image layer, and compositing the effective bottom image layer with upper image layers thereabove, and not compositing the effective bottom image layer with an image layer thereunder.

Determining image layers to be composited in each tile area includes assigning an order in which two or more image layers are to he read from the top image layer to the bottom image layer.

Compositing the effective bottom image layer with the upper image layers comprises compositing image layers by reading data of the image layers in an order from the effective bottom image layer to the top image layer.

Compositing the image layers by reading data of the image layers in the order from the effective bottom image layer to the top image layer comprises reading data of the effective bottom image layer, reading data of a first upper image layer above the effective bottom image layer, generating an intermediate composite image layer by compositing the effective bottom image layer with the first upper image layer, and storing the intermediate composite image layer.

Compositing the image layers by reading data of the image layers in the order from the effective bottom image layer to the top image layer comprises reading data of a second upper image layer above the effective bottom image layer and compositing the intermediate composite image layer with the second upper image layer and storing the new composite image layer.

According to an exemplary embodiment of the present inventive concept, there is provided a method for providing a composition of multi image layers, the method including reading image layer information in an order from a top image layer to a bottom image layer, determining whether to read a lower image layer using the image layer information of the image layers above the lower image layer, if the lower image layer is determined not to be read, defining the image layer above the lower image layer as an effective bottom image layer, and compositing the effective bottom image layer with the image layers thereabove by reading image layer data in an order from the effective bottom image layer to the top image layer.

The method further comprises assigning an order in which two or more image layers have their image information read from the top image layer to the bottom image layer.

Compositing by reading the image layer data in the order from the effective bottom image layer to the top image layer comprises reading data of the effective bottom image layer, reading data of an upper image layer above the effective bottom image layer, generating a composite image layer by compositing the effective bottom image layer with the upper image layer, and storing the composite image layer.

Compositing by reading the image layer data in the order from the effective bottom image layer to the top image layer comprises reading data of a next upper image layer above the effective bottom image layer, compositing the composite image layer with the next upper image layer, and storing the new composite image layer.

If the lower image layer is to be read, the method further comprises determining whether to read a next lower image layer using the image layer information of the lower image layer.

The image layer information includes a color format, a user defined transparency, or a compositing method.

When the color format includes an alpha channel and an image layer is treated as an opaque image layer, the method further comprises converting the color format such that the alpha-channel is ignored.

The image layer information includes a raster operations pipeline (ROP) rule, and the compositing of the effective bottom image layer with the image layers thereabove by reading the image layer data in the order from the effective bottom image layer to the top image layer comprises performing an ROP rule.

The image layer information includes color key information, and the compositing of the effective bottom image layer with the image layers thereabove by reading the image layer data in the order from the effective bottom image layer to the top image layer comprises performing a color key operation.

The image layer information includes position information, an alpha channel value and transparency information of the image layers.

According to an exemplary embodiment of the present inventive concept, there is provided a device for providing a composition of multi image layers, the device including: an image layer manager to read information about a plurality of image layers and define an effective bottom image layer; a read buffer to access a memory and read at least some of the image layers; and an image composition engine to perform composition of the effective bottom image layer with upper image layers while not performing composition of the effective bottom image layer with lower image layers, and generate a composite image layer.

The image layer manager reads the information of the image layers in an order from a top image layer to a bottom image layer, determines whether to read a lower image layer using the information of the image layers, and if the lower image layer is determined not to be read, defines an image layer above the lower image layer as the effective bottom image layer.

The image layer manager controls the read buffer to read the image layers in an order from the effective bottom image layer to a top image layer.

The read buffer accesses the memory to read the composite image layer at an intermediate step.

The device may further include a write buffer to receive the composite image layer from the image composition engine, and write the composite image layer to the memory.

### BRIEF DESCRIPTION OF THE DRAWINGS

The above and other features of the present inventive concept will become more apparent by describing in detail exemplary embodiments thereof with reference to the attached drawings in which:

FIG. 1 is a flowchart illustrating a method for providing a composition of multi image layers according to an exemplary embodiment of the present inventive concept;

FIG. 2 is a flowchart illustrating a step of defining an effective bottom image layer shown in FIG. 1, according to an exemplary embodiment of the present inventive concept;

FIG. 3 is a diagram illustrating the step of defining an effective bottom image layer shown in FIG. 1, according to an exemplary embodiment of the present inventive concept;

FIG. 4 is a flowchart illustrating a step of providing a composition of at least some of a plurality of source image layers shown in FIG. 1, according to an exemplary embodiment of the present inventive concept;

FIG. 5 is a diagram illustrating the step of providing a composition of at least some of a plurality of source image layers shown in FIG. 1, according to an exemplary embodiment of the present inventive concept;

FIG. 6 is a block diagram illustrating an image composition module according to an exemplary embodiment of the present inventive concept;

FIG. 7 is a diagram illustrating a source image layer, according to an exemplary embodiment of the present inventive concept;

FIG. 8 is a block diagram illustrating the image composition module shown in FIG. 6, according to an exemplary embodiment of the present inventive concept;

FIG. 9 is a block diagram illustrating an application example of the image composition module shown in FIG. 8, according to an exemplary embodiment of the present inventive concept;

FIG. 10 illustrates an application example of a method for providing a composition of multi image layers according to an exemplary embodiment of the present inventive concept; and

FIG. 11 is a block diagram illustrating a system on chip for performing a method for providing a composition of multi image layers according to an exemplary embodiment Of the present inventive concept.

### DETAILED DESCRIPTION OF THE EMBODIMENTS

Exemplary embodiments of the present inventive concept will now be described more fully hereinafter with reference to the accompanying drawings. This inventive concept may, however, be embodied in different forms and should not be construed as limited to the embodiments set forth herein. The same reference numbers may indicate the same components throughout the specification and drawings. In the attached figures, the thickness of elements, layers or regions may be exaggerated for clarity.

The use of the terms “a,” “an,” the and similar referents in the context of describing the inventive concept (especially in the context of the following claims) are to be construed to cover both the singular and the plural, unless otherwise indicated herein.

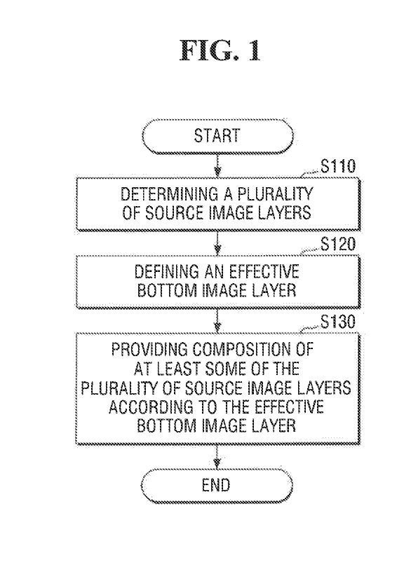

FIG. 1 is a flowchart illustrating a method for providing a composition of multi image layers according to an exemplary embodiment of the present inventive concept.

Referring to FIG. 1, the method for providing a composition of multi image layers according to an exemplary embodiment of the present inventive concept includes determining a plurality of source image layers to be subjected to composition (S110). In other words, combined. The plurality of source image layers may be stored in a frame buffer. Here, an order of the plurality of source image layers may be assigned from the top image layer to the bottom image layer. For example, the order of the plurality of source image layers may be assigned based on an order stored in the frame buffer or an order searched from the frame buffer, but exemplary embodiments of the present inventive concept are not limited thereto.

Next, an effective bottom image layer is defined (S120). Here, it is determined whether to read a lower image layer during image composition while reading information about the plurality of source image layers in an order from the top image layer to the bottom image layer (in other words, in a top-down manner). For example, it is determined that a lower image layer that is shielded by an upper image layer to be made invisible in a composite image layer does not have to be read.

The need for reading the lower image layer may be determined using the current source image layer information. Thus, a source image layer whose lower image layer does not have to be read may be defined as an effective bottom image layer. According to an exemplary embodiment of the inventive concept, the need for reading the lower image layer may also be determined based on the current source image layer information and the lower image layer information.

Next, at least some of the plurality of source image layers are composited (e.g., combined) based on the effective bottom image layer (S130). The at least some of the plurality of source image layers may include the effective bottom image layer and image layers above the effective bottom image layer. Here, composition may be performed on the at least some of the plurality of source image layers while reading data of the plurality of source image layers in an order from the effective bottom image layer to the top image layer (in other words, in a bottom-up manner).

Therefore, in the method for providing a composition of multi image layers according to the present inventive concept, the plurality of source image layers are composited in the order from the effective bottom image layer to the top image layer, and the plurality of source image layers that are not to be composited are not read, thereby reducing the number of accesses to a memory (e.g., a frame buffer).

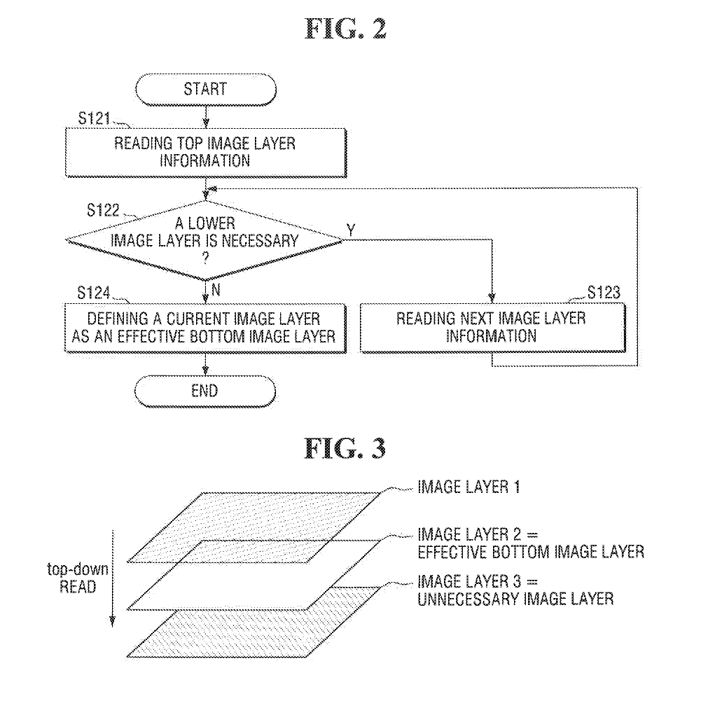

FIG. 2 is a flowchart illustrating a step of defining an effective bottom image layer shown in FIG. 1, according to an exemplary embodiment of the present inventive concept, and FIG. 3 is a diagram illustrating the step of defining an effective bottom image layer shown in FIG. 1, according to an exemplary embodiment of the present inventive concept,

In FIG. 3, it is assumed that a first image layer (IMAGE LAYER 1) is a top image layer and a third image layer (IMAGE LAYER 3) is a bottom image layer. A second image layer (IMAGE LAYER 2) is a source image layer positioned below the first image layer and above the third image layer.

Referring to FIGS. 2 and 3, in the defining of the effective bottom image layer, top image layer information is first read (S121). Transparency of the first image layer may be read as the first image layer information. For example, the first image layer may be a transparent image layer.

Next, it is determined whether a lower image layer beneath the top image layer is necessary (S122). Since the first image layer is a transparent image layer, it is determined that the second image layer (positioned below the first image layer) needs to be read during image composition.

Next, if the lower image layer is necessary, information of a next lower image layer is read (S123). In other words, information of a layer below the lower layer, just checked is read. After the information is read, the step S122 is again performed to determine whether a lower image layer beneath the next lower image layer is necessary. For example, the second image layer may be an opaque image layer. Since the second image layer is an opaque image layer, it is determined that the third image layer (positioned below the second image layer) does not have to he read during image composition.

Next, if the lower image layer of a current image layer is not necessary, in other words, if it is not necessary to read the lower image layer during image composition, the current image layer is defined as the effective bottom image layer (S124). As described above, since it is not necessary to read the third image layer during image composition, the second image layer is defined as the effective bottom image layer.

In addition, if no further source image layer to read exists (in other words, if information has already been read from the bottom image layer), the bottom image layer is defined as the effective bottom image layer.

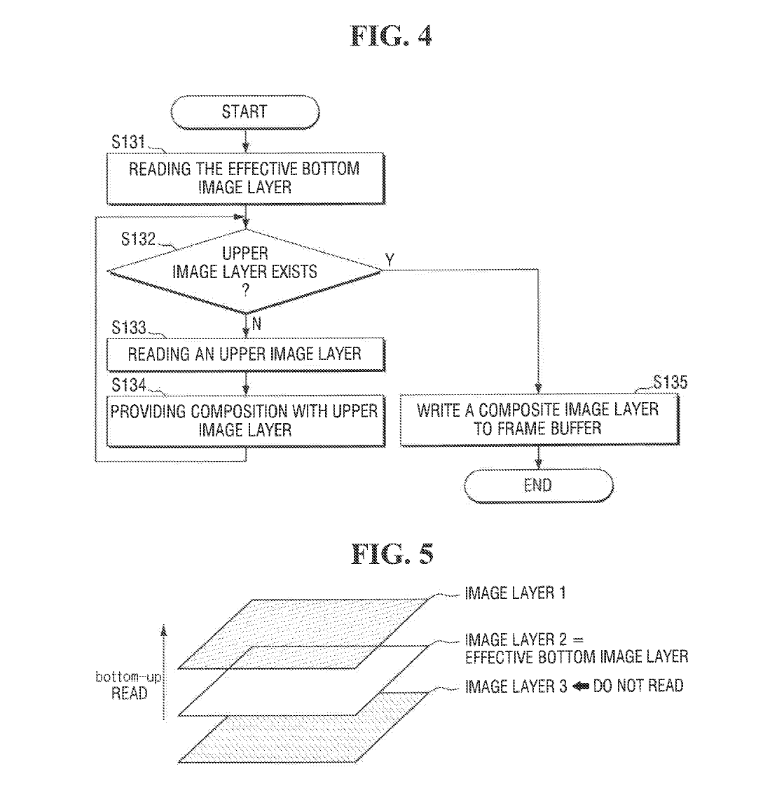

FIG. 4 is a flowchart illustrating a step of providing a composition of at least some of a plurality of source image layers shown in FIG. 1, according to an exemplary embodiment of the present inventive concept, and FIG. 5 is a diagram illustrating the step of providing a composition of at least some of a plurality of source image layers shown in FIG. 1, according to an exemplary embodiment of the present inventive concept.

In FIG. 5, it is assumed that a first image layer (IMAGE LAYER 1) is a top image layer and a third image layer (IMAGE LAYER 3) is a bottom image layer. A second image layer (IMAGE LAYER 2) is a source image layer positioned below the first image layer and above the third image layer.

Referring to FIG. 4, the performing of the composition of at least some of the plurality of source image layers comprises reading an effective bottom image layer (S131). Since the second image layer is defined as the effective bottom image layer, second image layer data may be read.

Next, it is determined whether an upper image layer exists (S132). In other words, it is determined that the first image layer positioned above the second image layer exists,

Next, if an upper image layer exists, the upper image layer is read (S133). Since the first image layer exists, first image layer data may be read.

Next, composition of the upper image layer with the effective bottom image layer is performed (S134). Composition of the second image layer with the first image layer is performed to generate a composite image layer.

Next, the step S132 is again performed to determine whether a next upper image layer exists. If a next upper image layer exists, data of the next upper image layer may be read. Then, composition of the composite image layer with the next upper image layer may be performed, thereby generating a new composite image layer.

In addition, if no further upper image layer exists (in other words, if the top image layer is already part of the composite image layer), the composite image layer is written to a frame buffer (S135).

It is to be understood, that the performing of the composition of at least some of the plurality of source image layers may further include storing the composite image layer in intermediate steps.

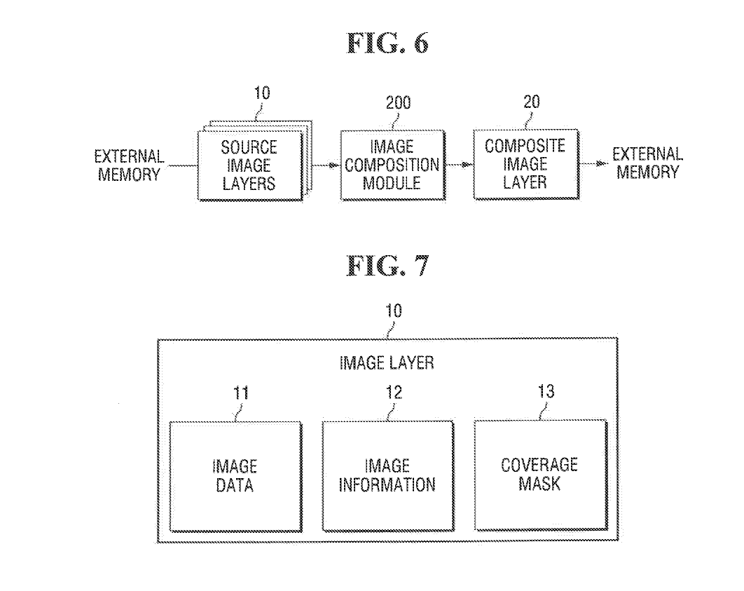

FIG. 6 is a block diagram illustrating an image composition module according to an exemplary embodiment of the present inventive concept.

Referring to FIG. 6, an image composition module 200 according to an exemplary embodiment of the present inventive concept receives a plurality source image layers 10 from an external memory and transmits a composite image layer 20 to the external memory. The image composition module 200 may perform the method for providing a composition of multi image layers, according to an exemplary embodiment of the present inventive concept. The image composition module 200 may perform composition of at least some of the plurality source image layers 10 to generate the composite image layer 20. A frame buffer may be provided within a storage area of the external memory.

FIG. 7 is a diagram illustrating one of the source image layers, according to an exemplary embodiment of the present inventive concept.

Referring to FIG. 7, the source image layer 10 includes image data 11 and image information 12. According to an exemplary embodiment of the present inventive concept, the source image layer 10 may include a coverage mask 13. It is to be understood, that each of the source image layers 10 may be the same as or similar to the source image layer 10 of FIG. 7.

The image data 11 may be actual image data including pixel information of the source image layer 10. The image data 11 may be used in performing composition of the source image layer 10 with other source image layers 10.

The image information 12 may include, for example, a color format, user defined transparency, and a composition method of the image data 11, but exemplary embodiments of the present inventive concept are not limited thereto. The image information 12 may include, for example, position information the source image layer 10, an alpha channel value of the source image layer 10 and transparency information of the source image layer 10. The position information may include, for example, a start point, a width, and a height of the source image layer 10. The position information may also include coordinates of a plurality of corners of the source image layer 10. In this case, the coordinates of the plurality of corners may include coordinates of a left-top corner and a right-bottom corner.

The image information 12 may be used in defining the effective bottom image layer. In the embodiment illustrated in FIGS. 2 and 3, transparency is used as the image information 12, but exemplary embodiments of the present inventive concept are not limited thereto. The image information 12 may include a wide variety of information.

For example, when a raster operations pipeline (ROP) is performed in performing composition of the source image layers 10, the image information 12 may include an ROP rule. Alternatively, when a color key operation is performed in performing composition of the source image layers 10, the image information 12 may include color key information. When a color format includes an alpha channel and a particular source image layer 10 is treated as an opaque image layer, a pre-processing step may further be performed to convert the color format of the source image layer 10 such that the alpha channel can be ignored.

The coverage mask 13 may refer to a screen area occupied by the source image layer 10 in total or in part. As will later be described, the coverage mask 13 may divide a storage area of the frame buffer into a plurality of tile areas, and may be used in determining whether to perform composition of the plurality of source image layers 10 with respect to the tile areas.

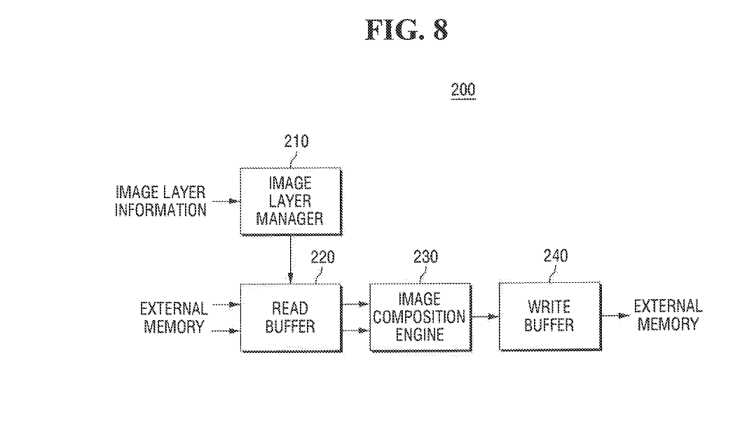

FIG. 8 is a block diagram illustrating the image composition module shown in FIG. 6, according to an exemplary embodiment of the present inventive concept.

Referring to FIG. 8, the image composition module 200 includes an image layer manager 210, a read buffer 220, an image composition engine 230, and a write buffer 240.

The image layer manager 210 may read information about the plurality of source image layers. The image layer manager 210 may determine whether it is necessary to read a lower image layer in performing composition by reading the information about the plurality of source image layers in an order from the top image layer to the bottom image layer. In addition, the image layer manager 210 may define the source image layer whose lower image layer is determined to not have to be read as an effective bottom image layer. The image layer manager 210 may control the read buffer 220 according to the effective bottom image layer.

The read buffer 220 may access an external memory to read at least some of the plurality of source image layers stored in the external memory. The at least some of the plurality of source image layers may include the effective bottom image layer and upper image layers positioned above the effective bottom image layer. The read buffer 220 may read data of the source image layers. The read buffer 220, controlled by the image layer manager 210, may read the plurality of source image layers in an order from the effective bottom image layer to the top image layer. The read buffer 220 may read composite image layers at intermediate steps during the process, since the composite image layers may he stored in the external memory.

The image composition engine 230 may receive the plurality of source image layers from the read buffer 220. The image composition engine 230 may perform composition of the plurality of source image layers to generate a composite image layer.

The image composition engine 230 may receive a composite image layer of a previous step from the read buffer 220 and may perform composition of the composite image layer with a next source image layer to generate a new composite image layer. The image composition engine 230 may transmit the composite image layer to the write buffer 240.

The write buffer 240 may access the external memory to write composite image layers at intermediate steps to the external memory. The write buffer 240 may write the completed composite image layer to the external memory.

Therefore, in the image composition module 200 according to the current embodiment of the present inventive concept, composition of the effective bottom image layer with an upper image layer is performed while not performing composition of the effective bottom image layer with lower image layers, thereby reducing the number of accesses to a memory.

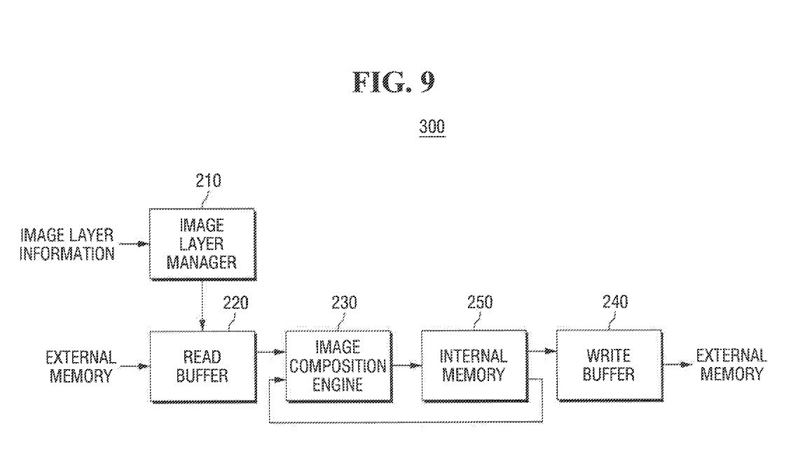

FIG. 9 is a block diagram illustrating an application example of the image composition module shown in FIG. 8, according to an exemplary embodiment of the present inventive concept. For the sake of convenience, the following description will focus on differences between the image composition modules shown in FIGS. 8 and 9.

Referring to FIG. 9, an image composition module 300 may further include an internal memory 250.

The image composition engine 230 may receive a composite image layer of a previous step from the internal memory 250. The image composition engine 230 may write composite image layers at intermediate steps to the internal memory 250.

The internal memory 250 may temporarily store the composite image layers at intermediate steps. If the performing of the composition by the image composition engine 230 is completed, the internal memory 250 may transmit the completed composite image layer to the write buffer 240.

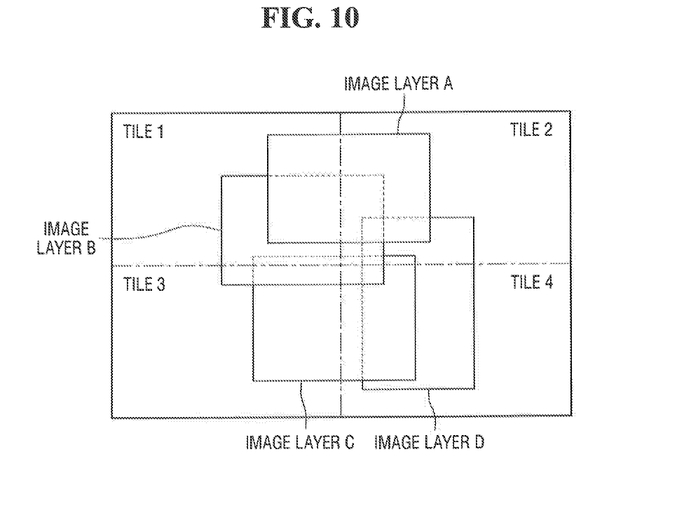

FIG. 10 illustrates an application example of a method for providing a composition of multi image layers according to an exemplary embodiment of the present inventive concept

Referring to FIG. 10, a screen area of a display device may be divided into a plurality of areas, Each of the divided areas may be referred to as a tile (e.g., tiles 1 to 4). A storage area of a frame buffer may also be divided into a plurality of areas corresponding to the respective tiles.

In a method for providing a composition of multi image layers according to an exemplary embodiment of the present inventive concept, a storage area of a frame buffer may be divided into tile areas and a plurality of source image layers may be determined to be subject to composition for the respective tile areas. In addition, an effective bottom image layer is defined for each tile area, and composition of the source image layer is performed for the respective tile areas, thereby generating a composite image layer for the respective tile areas.

For example, since a first tile area (e.g., the 1) shown in FIG. 10 is partially occupied by three source image layers (e.g., image layers A, B and C), composition of the three source image layers is performed to generate a composite image layer for the first tile area. Here, only data corresponding to the areas occupied by the respective source image layers may be used in performing the composition of the three source image layers.

Thereafter, composite image layers resulting from the performing of the composition with respect to the respective tile areas (e.g., tiles 1 to 4) are merged, thereby completing the overall composite image layer.

Each of the plurality of source image layers may have a size smaller than the screen area of the display device. In addition, each of the plurality of source image layers may have a rectangular shape, but exemplary embodiments of the present inventive concept are not limited thereto.

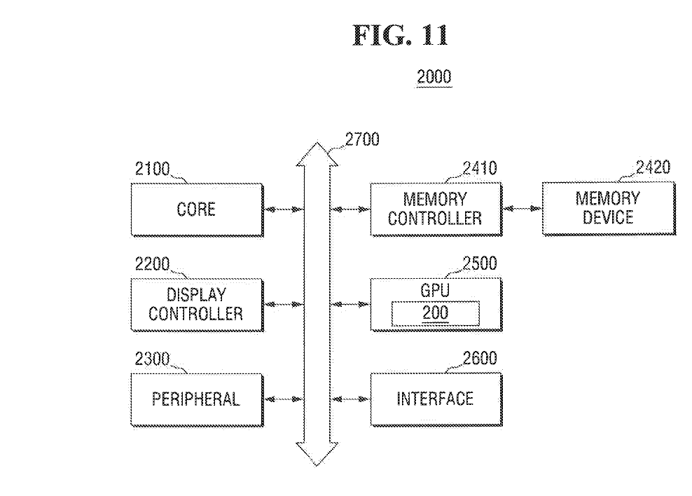

FIG. 11 is a block diagram illustrating a system on chip for performing a method for providing a composition of multi image layers according to an exemplary embodiment of the present inventive concept.

A system on chip 2000 may include a core device (CORE) 2100, a display controller 2200, a peripheral device (PERIPHERAL) 2300, a memory controller 2410, a memory device 2420, a graphic processing system (GPU) 2500, an interface device (INTERFACE) 2600, and a data bus 2700.

The core device 2100, the display controller 2200, the peripheral device 2300, the memory system 2400, the graphic processing system 2500, and the interface device 2600 may be connected to each other through the data bus 2700. The data bus 2700 may correspond to a path through which data moves.

The core device 2100 may include one processor core (e.g., a single-core) or a plurality of processor cores (e.g., a multi-core) to process data. For example, the core device 2100 may be a multi-core, such as a dual-core, a quad-core or a hexa-core. The core device 2100 may further include a cache memory positioned inside or outside of the control device 2100.

The display controller 2200 may control a display device, to allow the display device to display a picture or an image.

The peripheral device 2300 may include various devices, such as a serial communication device, a memory management device, and an audio processing device.

The memory controller 2410 may be configured to control the memory device 2420 and may exchange data with the memory device 2420.

The memory controller 2410 may provide data and/or commands to the memory device 2420. The memory device 2420 may be configured to store data and/or commands.

The memory device 2420 may include one or more volatile memories, such as a double data rate synchronous dynamic random access memory (DDR SDRAM) or a single data rate SDRAM (SDR SDRAM), and/or one or more non-volatile memories, such as an electrically erasable programmable read only memory (EEPROM) or a flash memory.

The graphic processing system 2500 may perform graphic operations and may process graphic data. The graphic processing system 2500 may include the image composition module 200 shown in FIGS. 8 and 9. The image composition module 200 may perform a method for providing a composition of multi image layers according to an exemplary embodiment of the present inventive concept as described with reference with FIG. 1.

The memory device 2420 may store the graphic data processed by the graphic processing system 2500 or may provide graphic data to the graphic processing system 2500. The memory device 2420 may provide a plurality of source image layers to the graphic processing system 2500 or may store composite image layers by performing a function of the external memory shown in FIGS. 8 and 9.

A graphic memory may be provided as an internal component of the graphic processing system 2500. In this case, the composite image layers produced at intermediate steps may be temporarily stored by performing a function of the internal memory 250 shown in FIG. 9.

The interface device 2600 may transmit data to a communication network or may receive data from the communication network. The interface device 2600 may include, for example, an antenna, a wired/wireless transceiver, and so on.

While the present inventive concept has been particularly shown and described with reference to exemplary embodiments thereof, it will be understood by those of ordinary skill in the art that various changes in form and detail may be made therein without departing from the spirit and scope of the present inventive concept as defined by the following claims.

What is claimed is:

1. A method for providing a composition of multi image layers, the method comprising:
dividing a storage area of a frame buffer into tile areas;
for each tile area, determining image layers to he composited;
for each tile area, generating a composite image layer by compositing its determined image layers; and
merging the composite image layers of the respective tile areas into an overall composite image layer;
wherein generating the composite image layer for at least one of the tile areas comprises:
reading image layer information of the image layers in an order from a top image layer to a bottom image layer;
determining whether to read a lower image layer using the information of the image layer above the lower image layer;
if the lower image layer is determined not to be read, defining the image layer above the lower image layer as an effective bottom image layer; and
compositing the effective bottom image layer with upper image layers thereabove, and not compositing the effective bottom image layer with an image layer thereunder.

2. The method of claim 1, wherein determining image layers to be composited each tile area includes assigning an order in which two or more image layers are to he read from the top image layer to the bottom image layer.

3. The method of claim 1, wherein compositing the effective bottom image layer with the upper image layers comprises compositing image layers by reading data of the image layers in an order from the effective bottom image layer to the top image layer.

4. The method of claim 3, wherein compositing the image layers by reading data of the image layers in the order from the effective bottom image layer to the top image layer comprises reading data of the effective bottom image layer, reading data of a first upper image layer above the effective bottom image layer, generating an intermediate composite image layer by compositing the effective bottom image layer with the first upper image layer, and storing the intermediate composite image layer.

5. The method of claim 4, wherein compositing the image layers by reading data of the image layers in the order from the effective bottom image layer to the top image layer comprises reading data of a second upper image layer above the effective bottom image layer and compositing the intermediate composite image layer with the second upper image layer, and storing the new composite image layer.

6. A method for providing a composition of multi image layers, the method comprising:
reading image layer information in an order from a top image layer to a bottom image layer;
determining whether to read a lower image layer using the image layer information of the image layers above the lower image layer;
if the lower image layer is determined not to be read, defining the image layer above the lower image layer as an effective bottom image layer; and
compositing the effective bottom image layer with the image layers thereabove by reading image layer data in an order from the effective bottom image layer to the top image layer.

7. The method of claim 6, further comprising assigning an order in which two or more image layers have their image information read from the top image layer to the bottom image layer.

8. The method of claim 6, wherein compositing by reading the image layer data in the order from the effective bottom image layer to the top image layer comprises reading data of the effective bottom image layer, reading data of an upper image layer above the effective bottom image layer, generating a composite image layer by compositing the effective bottom image layer with the upper image layer, and storing the composite image layer.

9. The method of claim 8, wherein compositing by reading the image layer data in the order from the effective bottom image layer to the top image layer comprises reading data of a next upper image layer above the effective bottom image layer, compositing the composite image layer with the next upper image layer, and storing the new composite image layer.

10. The method of claim 6, wherein if the lower image layer is to be read, the method further comprises determining whether to read a next lower image layer using the image layer information of the lower image layer.

11. The method of claim 6, wherein the image layer information includes a color format, a user defined transparency, or a compositing method.

12. The method of claim 11, wherein when the color format includes an alpha channel and an image layer is treated as an opaque image layer, the method further comprises converting the color format such that the alpha-channel is ignored.

13. The method of claim 6, wherein the image layer information includes a raster operations pipeline (ROP) rule, and the compositing of the effective bottom image layer with the image layers thereabove by reading the image layer data in the order from the effective bottom image layer to the top image layer comprises performing an ROP rule.

14. The method of claim 6, wherein the image layer information includes color key information, and the compositing of the effective bottom image layer with the image layers thereabove by reading the image layer data in the order from the effective bottom image layer to the top image layer comprises performing a color key operation.

15. The method of claim 6, wherein the image layer information includes position information, an alpha channel value and transparency information of the image layers.

16. A device for providing a composition of multi image layers, the device comprising:
an image layer manager to read information about a. plurality of image layers and define an effective bottom image layer;
a read buffer to access a memory and read at least some of the image layers; and
an image composition engine to perform composition of the effective bottom image layer with upper image layers while not performing composition of the effective bottom image layer with lower image layers, and generate a composite image layer.

17. The device of claim 16, wherein the image layer manager reads the information of the image layers in an order from a top image layer to a bottom image layer, determines whether to read a lower image layer using the information of the image layers, and if the lower image layer is determined not to be read, defines an image layer above the lower image layer as the effective bottom image layer.

18. The device of claim 16, wherein the image layer manager controls the read buffer to read the image layers in an order from the effective bottom image layer to a top image layer.

19. The device of claim 18, wherein the read buffer accesses the memory to read the composite image layer at an intermediate step.

20. The device of claim 16, further comprising a write buffer to receive the composite image layer from the image composition engine, and write the composite image layer to the memory.
